(19) United States
(12) Patent Application Publication
(10) Pub. No.: US 2026/0237120 A1
(43) Pub. Date: Aug. 13, 2026

(54) EFFECT PROCESSING METHOD AND APPARATUS, ELECTRONIC DEVICE AND STORAGE MEDIUM

(71) Applicant: Beijing Zitiao Network Technology Co., Ltd., Beijing (CN)

(72) Inventor: Weike XING, Beijing (CN)

(21) Appl. No.: 19/160,784

(22) PCT Filed: Oct. 24, 2024
(86) PCT No.: PCT/CN2024/127082

§ 371 Date: Aug. 28, 2025

(30) Foreign Application Priority Data
Nov. 3, 2023 (CN) 202311460302.2

(51) Int. Cl. G06T 11/60; H04N 5/45

(52) U.S. Cl. CPC G06T 11/60; H04N 5/45

(57) ABSTRACT

Embodiments of the present disclosure provide an effect processing method and apparatus, an electronic device, and a storage medium. The method includes: sending a target image to a first process and a second process in response to an effect trial request being received; processing the target image in the first process according to a first parameter; and processing the target image in the second process according to a second parameter to perform effect trial preview.

### CROSS-REFERENCE TO RELATED APPLICATION(S)

This application is a national stage application filed under 35 U.S.C. 371 based on International Patent Application No. PCT/CN2024/127082, filed Oct. 24, 2024, which claims priority to Chinese Patent Application No. 202311460302.2 filed on Nov. 3, 2023, the entire disclosures of which are incorporated herein by reference in their entireties.

### FIELD

Embodiments of the present disclosure relate to data processing technology, and in particular, to an effect processing method and apparatus, an electronic device, and a storage medium.

### BACKGROUND

In a real-time shooting or live streaming scenario, effects usually need to be added to a real-time video to enrich content of the video. At present, in the real-time shooting or live streaming scenario, there may be a case that an effect needs to be adjusted. If another effect is desired to be used instead, an effect of the to-be-replaced effect needs to be previewed in advance, and then whether to use the effect is determined.

### SUMMARY

The present disclosure provides a method and an apparatus for generating a media information material, an electronic device, and a storage medium.

In a first aspect, an embodiment of the present disclosure provides an effect processing method, including:
sending a target image to a first process and a second process in response to an effect trial request being received;
processing the target image in the first process according to a first parameter, the first parameter being a parameter adopted before the effect trial request is received; and
processing the target image in the second process according to a second parameter to perform effect trial preview, the second parameter being an effect parameter corresponding to the effect trial request.

In a second aspect, an embodiment of the present disclosure further provides an effect processing apparatus, including:
an image sending module, configured to send a target image to a first process and a second process when an effect trial request is received;
a first rendering module, configured to process the target image in the first process according to a first parameter, where the first parameter is a parameter adopted before the effect trial request is received; and
a second rendering module, configured to process the target image in the second process according to a second parameter to perform effect trial preview, where the second parameter is an effect parameter corresponding to the effect trial request.

In a third aspect, an embodiment of the present disclosure further provides an electronic device, including:
one or more processors; and
a storage apparatus, configured to store one or more programs,
when the one or more programs are executed by the one or more processors, the one or more processors are caused to implement the effect processing method according to any embodiment of the present disclosure.

In a fourth aspect, a storage medium includes computer-executable instructions, and when the computer-executable instructions are executed by a computer processor, the effect processing method according to any embodiment of the present disclosure is performed.

### BRIEF DESCRIPTION OF THE DRAWINGS

The above and other features, advantages, and aspects of the embodiments of the present disclosure will become more apparent in combination with the drawings and with reference to the following specific embodiments. Throughout the drawings, the same or similar reference numerals denote the same or similar elements. It should be understood that the drawings are schematic and that parts and elements are not necessarily drawn to scale.

FIG. 1a is a schematic flowchart of an effect processing method according to an embodiment of the present disclosure;

FIG. 1b is a schematic diagram of a distribution of a first image and a second image presented on a target page to which the embodiments of the present disclosure are applicable;

FIG. 1c is a schematic diagram of a distribution of a first image and a second image presented on a target page to which the embodiments of the present disclosure are applicable;

FIG. 1d is a schematic diagram of a distribution of a first image and a second image presented on a target page to which the embodiments of the present disclosure are applicable;

FIG. 1f is a schematic diagram of a distribution of a first image and a second image presented on a target page to which the embodiments of the present disclosure are applicable;

FIG. 2 is a schematic diagram of effect processing by using the effect processing method according to the embodiments of the present application;

FIG. 3 is a schematic diagram of a structure of an effect processing apparatus according to an embodiment of the present disclosure; and

FIG. 4 is a schematic diagram of a structure of an electronic device according to an embodiment of the present disclosure.

### DETAILED DESCRIPTION OF EMBODIMENTS

Hereinafter, embodiments of the present disclosure will be described in more detail with reference to the drawings. Although some embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and embodiments of the present disclosure are only used for illustrative purposes, and are not used to limit a protection scope of the present disclosure.

It should be understood that steps described in method implementations of the present disclosure may be performed in different orders and/or in parallel. Furthermore, the method implementations may include additional steps and/or omit performing illustrated steps. The scope of the present disclosure is not limited in this respect.

As used herein, the term “include/comprise” and its variations are open-ended inclusions, that is, “include/comprise but not limited to”. The term “based on” means “at least partially based on”. The term “one embodiment” means “at least one embodiment”. The term “another embodiment” means “at least one other embodiment”. The term “some embodiments” means “at least some embodiments”. Relevant definitions of other terms will be given in the following description.

It should be noted that concepts such as “first” and “second” mentioned in the present disclosure are only used to distinguish different apparatuses, modules, or units, and are not used to limit an order or interdependence of functions performed by these apparatuses, modules, or units.

It should be noted that modifications of “one” and “multiple” mentioned in the present disclosure are illustrative rather than restrictive, and those skilled in the art should understand that unless otherwise explicitly specified in the context, they should be understood as “one or multiple”.

Names of messages or information exchanged between multiple apparatuses in the implementations of the present disclosure are only used for illustrative purposes, and are not used to limit the scope of these messages or information.

It may be understood that before using the technical solutions disclosed in the embodiments of the present disclosure, users should be informed of the type, range of use, use scenarios, etc., of personal information involved in the present disclosure and obtain the authorization of the users in an appropriate manner in accordance with relevant laws and regulations.

For example, in response to receiving an active request from a user, prompt information is sent to the user to clearly prompt the user that the requested operation will need to access and use personal information of the user. In this way, the user may independently choose, according to the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, and the prompt information may be presented in the pop-up window in text. In addition, the pop-up window may also include a selection control for the user to select “agree” or “disagree” to provide the personal information to the electronic device.

It may be understood that the above process of notifying and obtaining user authorization is only illustrative and does not limit the implementations of the present disclosure. Other manners that satisfy relevant laws and regulations may also be applied to the implementations of the present disclosure.

As mentioned above, in the real-time shooting or live streaming scenario, there may be a case that an effect needs to be adjusted. If another effect is desired to be used instead, an effect of the to-be-replaced effect needs to be previewed in advance, and then whether to use the effect is determined. However, this will undoubtedly lead to a sudden increase in memory occupancy required in the real-time shooting or live streaming process, which may cause stuttering in the real-time shooting or live streaming process and seriously affect the real-time shooting or live streaming process.

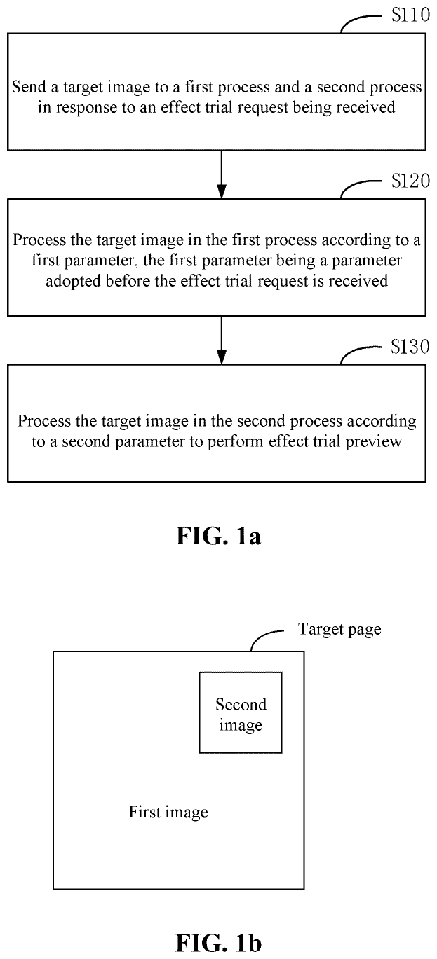

FIG. 1a is a schematic flowchart of an effect processing method according to an embodiment of the present disclosure. The embodiment of the present disclosure is applicable to a case of effect adjustment in a real-time shooting or live streaming scenario. The method may be performed by an effect processing apparatus, and the effect processing apparatus may be implemented in the form of software and/or hardware. Optionally, the method is implemented by an electronic device, and the electronic device may be a mobile terminal, a PC, a server, or the like.

As shown in FIG. 1a, the effect processing method in this embodiment includes the following steps.
S110: A target image is sent to a first process and a second process when an effect trial request is received.

The effect trial request may be an effect preview request, the first process may be a current process of real-time shooting or live streaming, the second process may be a process temporarily established for effect trial, and when the effect trial request ends, the second process is closed at the same time. The target image may be data acquired by an image acquiring apparatus (camera).

Specifically, the image acquiring apparatus (such as a camera) is controlled by the first process to acquire the target image, the acquired target image is sent to the first process, and the obtained target image is sent by the first process to the second process across processes.

Optionally, before the target image is sent to the first process and the second process, the method further includes: creating the second process in response to a first operation for triggering an effect trial task, so as to subsequently perform effect trial by using the second process, thereby avoiding the problem of excessive memory occupancy caused by the effect trial being directly performed in the first process, and greatly reducing the memory consumption of the first process. The first operation includes a trigger operation for an identification of the effect trial request presented on the target page. The first process and the second process are independent of each other in effect processing.
S120: The target image is processed in the first process according to a first parameter, where the first parameter is a parameter adopted before the effect trial request is received.

The first parameter may be a parameter that is adopted before the effect trial request is received and that is used for rendering the target image. The operation of performing, in the second process, effect processing according to the second parameter avoids a situation in which the effect processing process of the second parameter occupies the memory resources of the first process, causing a crash, a black screen, or the like and affecting a task being executed by the first process, thereby solving the problem of an ongoing live streaming or real-time shooting being interrupted due to the fact that an effect cannot be normally used.

Optionally, the processing of the target image in the first process according to the first parameter includes: performing, in the first process, effect processing on the target image according to the first parameter and performing rendering display on a target page, where the target page is a page that is created by the first process and that is used for rendering display.

The first parameter may be a parameter that is adopted before the effect trial request is received and that is used for performing effect processing on the target image and rendering the target image.

Specifically, the processing of the target image in the first process according to the first parameter and the rendering display on the target page may be more specifically described as follows: determining the first parameter adopted by the first process after the effect trial request is received, performing first effect processing on the target image by the first process according to the first parameter to obtain a first effect image, and performing rendering display on the first effect image on the target page corresponding to the first process. The first effect processing may be a processing process of effectively displaying an effect on the target page.

The target page is a page that is created by the first process and that is used for rendering display, for example, a display screen during live streaming. The target page may include two images, where a large display image is used to display images during live streaming, and a small image is used to display the effect of the effect parameter after the effect processing in the second process. The first parameter is a parameter adopted before the effect trial request is received, that is, if no effect is used before the effect trial request is received, the first parameter does not include an effect parameter, and if there is an effect that has been used before the effect trial request is received, the first parameter includes the effect parameter that is used previously.

With the above solution, the first parameter participates in the rendering of the target image and the effect processing of the target image in the first process, and a large amount of memory resources have been occupied. When an effect is tried, if the second parameter is further used for using the effect in the first process, the effect processing process of the second parameter will occupy a large amount of memory resources of the first process, causing a crash, a black screen, or the like and affecting the task being executed by the first process. Therefore, the operation of performing, in the second process, effect processing according to the second parameter avoids the effect processing of the second parameter from occupying the memory resources of the first process.

The method of the present application is applied to a first client. Further, the first effect image obtained by performing effect processing on the target image in the first process is pushed to a server, so that the server sends the first effect image to a second client for rendering display, thereby implementing interaction with a user.

Optionally, the image presented on the target page is explained in detail as follows.

A first image and a second image are presented on the target page. The first image is rendered and displayed on both the target page and other clients, and the second image is only rendered and displayed on the target page. The first image is an image rendered after the target image is processed by using the first parameter, and the second image is an image rendered after the target image is processed by using the second parameter. The first image and the second image are displayed on the target page in a screen splitting manner, a picture-in-picture manner, or the second image is superimposed over the first image, and these cases may be freely switched according to use requirements. Exemplarily, there may be at least three cases in which the first image and the second image are presented on the target page.
Case 1: A display size of the second image on the target page is smaller than a display size of the first image on the target page, and the second image is displayed above the first image, as shown in FIG. 1b.
Case 2: A display size of the first image on the target page is smaller than a display size of the second image on the target page, and the first image is displayed above the second image, as shown in FIG. 1c.
Case 3: The first image and the second image are displayed side by side on the target page, and a display size, on the target page, of the image formed by the first image and the second image side by side is equal to a page size of the target page, as shown in FIGS. 1d and 1f.
S130: The target image is processed in the second process according to a second parameter to perform effect trial preview.

The second parameter is an effect parameter corresponding to the effect trial request.

Optionally, the first parameter is an effect parameter originally adopted, before the effect trial request is received, to implement a first category of effect, and the second parameter is an effect parameter correspondingly adopted, in the effect trial after the effect trial request is received, to implement a second category of effect. For example, the first parameter is an effect parameter originally adopted, before the effect trial request is received, to implement effect A, and the second parameter is an effect parameter correspondingly adopted, in the effect trial after the effect trial request is received, to implement effect B.

Optionally, the processing of the target image in the second process according to the second parameter includes: performing, in the second process, effect processing on the target image according to the second parameter and performing rendering display on the target page.

Specifically, the performing, in the second process, effect processing on the target image according to the second parameter and performing rendering display on the target page may be more specifically described as follows: determining the second parameter selected, in the second process, for effect trial from multiple effect parameters in response to a second operation for effect parameter selection after the effect trial request is triggered. The second operation is specifically a selection operation for an identification of one effect parameter of identifications of at least two effect parameters presented on the target page. After the second parameter selected for the effect trial after the effect trial request is triggered is determined, second effect processing is performed on the target image by the second process according to the second parameter to obtain a second effect image, and rendering display is performed on the second effect image on the target page.

In the above solution, the second effect parameter is processed in the second process, instead of being executed in the first process for live streaming or real-time shooting. In this way, on the one hand, the memory consumption of the first process is reduced, and the ongoing live streaming or real-time shooting is prevented from being interrupted due to a sudden doubling of the memory occupancy of the first process. On the other hand, a situation in which the task being executed by the first process is affected by a crash, a black screen, or the like in the processing process of the second parameter is avoided, and the occurrence of the ongoing live streaming or real-time shooting being interrupted due to the fact that the effect cannot be normally used is greatly reduced.

Further, the second effect image of the second process is rendered, by a preset display control, to the target page corresponding to the first process for display, so that the display of the effect may be effectively previewed, thereby determining whether the effect may be applied to the first process and whether the effect may be sent to the client. The preset display control is a control used to update a display page across processes. For example, the preset display control may be a remote view rendering control.

Optionally, after the performing, in the second process, effect processing on the target image according to the second parameter and performing rendering display on the target page, the method further includes: closing the second process and adjusting the first parameter adopted by the first process to the second parameter in response to a third operation for confirming adoption of the second parameter; and performing, in the first process, effect processing on the target image according to the second parameter and performing rendering display on the target page.

In the above process, it is confirmed that the second parameter may be used to well display the effect without affecting live streaming or real-time shooting, and then the first parameter adopted by the first process may be adjusted to the second parameter, so as to perform, in the first process, effect processing on the target image according to the second parameter and perform rendering display on the target page, so as to present a better display image. At this time, the second process does not need to be used, and the second process may be closed, thereby effectively avoiding additional memory consumption.

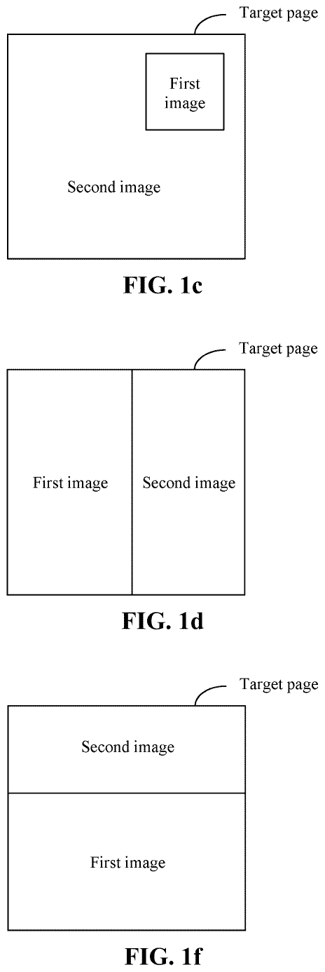

Exemplarily, the entire process of the present application is described by using live streaming as an example. As shown in FIG. 2, when a live streaming user is using a live streaming device (mobile phone or tablet) for live streaming and needs to switch an effect, the live streaming user clicks on an “effect trial” button on a page to trigger an effect trial task. At this time, a camera on the live streaming device acquires a target image and sends the target image to a first process and a second process.

The first process obtains a first parameter currently used by the first process, performs effect processing on the target image according to the first parameter, and renders the target image to a display screen of the live streaming device. At the same time, a first effect image obtained by performing effect processing on the target image in the first process is pushed to a server, so that the server distributes the first effect image to a second client for rendering display, thereby implementing interaction between the live streaming user and a viewing user.

After obtaining the target image, the second process receives a target effect that is determined by the live streaming user and needs to be switched to, obtains an effect parameter of the target effect, uses the effect parameter as a second parameter, and then performs, in the second process, effect processing on the target image according to the second parameter to obtain a second effect image. The second effect image is further rendered to the remote view in the second process, and the second effect image is rendered, by the remote view, across processes to the remote view in the first process and then to the display screen of the live streaming device. In this way, whether the second parameter may be normally applied is observed on the display screen of the live streaming device, that is, if an accident such as a black screen or a crash occurs, it indicates that the second parameter cannot be applied to the first process, thereby effectively avoiding the problem of live streaming interruption or the like caused by direct display of the effect in the first process. Moreover, the preview process is displayed in the second process, which may effectively reduce the memory consumption in the live streaming process of the first process, thereby improving the experience of the live streaming user.

It is determined that the second parameter may be adopted after preview display, and then the second process is closed and the first parameter adopted by the first process is adjusted to the second parameter, so as to perform, in the first process, effect processing on the target image according to the second parameter and perform rendering display on the target page.

In the technical solution of the embodiment of the present disclosure, the target image is sent to the first process and the second process when the effect trial request is received, then the target image is processed in the first process according to the first parameter and rendering display is performed, and at the same time, the target image is processed in the second process according to the second parameter and rendering display is performed, to perform effect trial preview. The operation of performing, in the second process, effect processing according to the second parameter avoids a situation in which the task being executed by the first process is affected by a crash, a black screen, or the like in the processing process of the second parameter, thereby solving the problem of an ongoing live streaming or real-time shooting being interrupted due to the fact that an effect cannot be normally used. In addition, the operation of performing, in the second process, effect processing according to the second parameter may also reduce the memory consumption of the first process, and avoid the ongoing live streaming or real-time shooting being interrupted due to a sudden doubling of the memory consumed by the first process, thereby realizing effective use of memory and smooth progress of the real-time shooting or live streaming process.

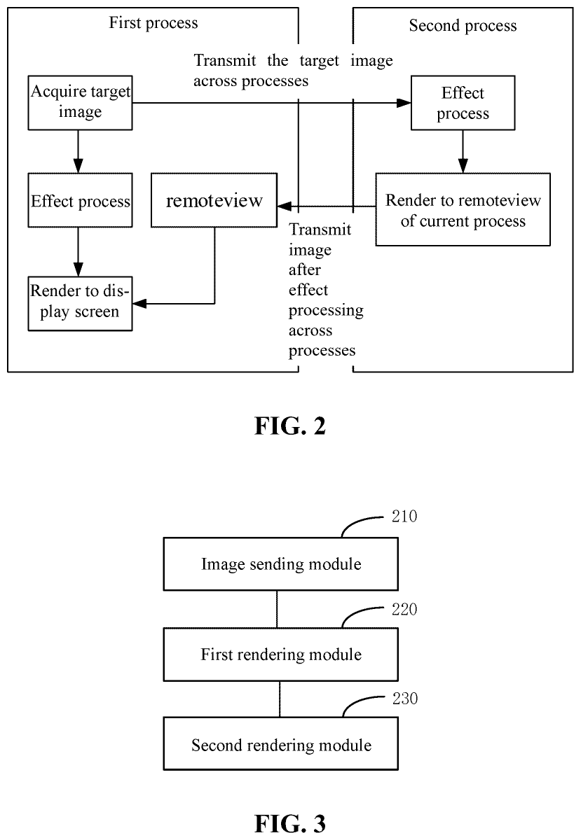

FIG. 3 is a schematic diagram of a structure of an effect processing apparatus according to an embodiment of the present disclosure. The embodiment of the present disclosure is applicable to a case of effect adjustment in a real-time shooting or live streaming scenario. The effect processing apparatus may be implemented in the form of software and/or hardware. Optionally, the apparatus is implemented by an electronic device, and the electronic device may be a mobile terminal, a PC, a server, or the like.

As shown in FIG. 3, the apparatus includes an image sending module 210, a first rendering module 220, and a second rendering module 230.

The image sending module 210 is configured to send a target image to a first process and a second process when an effect trial request is received;
the first rendering module 220 is configured to process the target image in the first process according to a first parameter, where the first parameter is a parameter adopted before the effect trial request is received; and
the second rendering module 230 is configured to process the target image in the second process according to a second parameter to perform effect trial preview, where the second parameter is an effect parameter corresponding to the effect trial request.

Optionally, the first rendering module is configured to perform, in the first process, effect processing on the target image according to the first parameter and perform rendering display on a target page, where the target page is a page that is created by the first process and that is used for rendering display.

Optionally, the second rendering module is configured to perform, in the second process, effect processing on the target image according to the second parameter and perform rendering display on the target page.

Optionally, a first image and a second image are presented on the target page, the first image is an image rendered after the target image is processed by using the first parameter, and the second image is an image rendered after the target image is processed by using the second parameter.

Optionally, the first image and the second image are displayed on the target page in a screen splitting manner, a picture-in-picture manner, or the second image is superimposed over the first image.

Optionally, the apparatus is applied to a first client, and the first rendering module further includes: a pushing unit, configured to push a first effect image obtained by performing effect processing on the target image in the first process to a server, so that the server sends the first effect image to a second client for rendering display.

Optionally, the image sending module further includes:

a creating unit, configured to create the second process in response to a first operation for triggering an effect trial task, where the first process and the second process are independent of each other in effect processing.

Optionally, the first operation includes a trigger operation for an identification of the effect trial request presented on the target page.

Optionally, the image sending module is configured to: control an image acquiring apparatus to acquire the target image by the first process; and send the acquired target image to the first process, and send the obtained target image by the first process to the second process across processes.

Optionally, the first rendering module is configured to: determine the first parameter adopted by the first process; perform first effect processing on the target image by the first process according to the first parameter to obtain a first effect image; and perform rendering display on the first effect image on the target page corresponding to the first process.

Optionally, the second rendering module is configured to: determine the second parameter selected for effect trial after the effect trial request is triggered; perform second effect processing on the target image by the second process according to the second parameter to obtain a second effect image; and render the second effect image of the second process to the target page for display by a preset display control, where the preset display control is a control used to update a display page across processes.

Optionally, the second rendering module further includes an effect determining unit, configured to: determine the second parameter selected, in the second process, for effect trial from multiple effect parameters in response to a second operation for effect parameter selection after the effect trial request is triggered.

Optionally, the second operation is specifically a selection operation for an identification of one effect parameter of identifications of at least two effect parameters presented on the target page.

Optionally, the second rendering module further includes an effect adopting unit, configured to: close the second process and adjust the first parameter adopted by the first process to the second parameter in response to a third operation for confirming adoption of the second parameter; and perform, in the first process, effect processing on the target image according to the second parameter and perform rendering display on the target page.

The effect processing apparatus provided by the embodiment of the present disclosure may perform the effect processing method provided by any embodiment of the present disclosure, and has function modules and beneficial effects corresponding to the method performed.

It is worth noting that the units and modules included in the above apparatus are only divided according to functional logic, but are not limited to the above division, as long as the corresponding functions may be implemented. In addition, the specific names of the functional units are only for the convenience of distinguishing between each other, and are not used to limit the protection scope of the embodiments of the present disclosure.

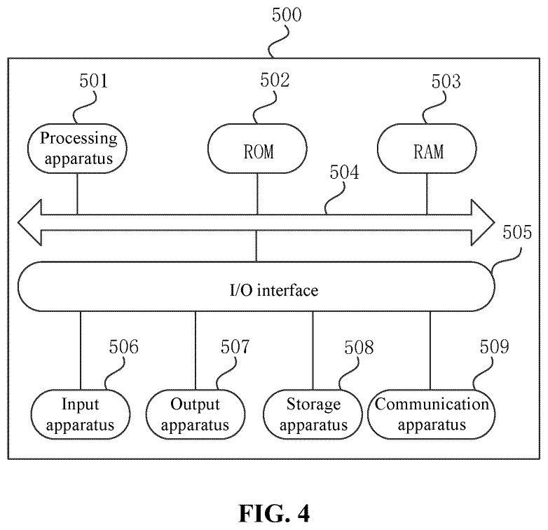

FIG. 4 is a schematic diagram of a structure of an electronic device according to an embodiment of the present disclosure. Reference is made to FIG. 4 below, which illustrates a schematic diagram of a structure of an electronic device (such as a terminal device or a server in FIG. 4) 500 suitable for implementing the embodiments of the present disclosure. The terminal device in the embodiments of the present disclosure may include, but is not limited to, mobile terminals such as a mobile phone, a notebook computer, a digital broadcast receiver, a PDA (personal digital assistant), a PAD (tablet computer), a PMP (portable multimedia player), and an in-vehicle terminal (such as an in-vehicle navigation terminal), and fixed terminals such as a digital TV and a desktop computer. The electronic device shown in FIG. 7 is merely an example, and shall not impose any limitation on the functions and scope of use of the embodiments of the present disclosure.

As shown in FIG. 4, the electronic device 500 may include a processing apparatus (such as a central processing unit and a graphics processor) 501, which may perform various appropriate actions and processing according to a program stored in a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to each other through a bus 504. An editing/output (I/O) interface 505 is also connected to the bus 504.

Usually, the following apparatuses may be connected to the I/O interface 505: an input apparatus 506 including, for example, a touch screen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a magnetic tape and a hard disk; and a communication apparatus 509. The communication apparatus 509 may allow the electronic device 500 to perform wireless or wired communication with other devices to exchange data. Although FIG. 7 shows the electronic device 500 having various apparatuses, it should be understood that it is not required to implement or have all the apparatuses shown. More or fewer apparatuses may be implemented or provided alternatively.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program includes program code for performing the method shown in the flowchart. In such an embodiment, the computer program may be downloaded and installed from a network through the communication apparatus 509, or installed from the storage apparatus 508, or installed from the ROM 502. When the computer program is executed by the processing apparatus 501, the preceding functions defined in the method of the embodiments of the present disclosure are performed.

Names of messages or information exchanged between multiple apparatuses in the implementations of the present disclosure are only used for illustrative purposes, and are not used to limit the scope of these messages or information.

The electronic device provided by the embodiment of the present disclosure belongs to the same inventive concept as the effect processing method provided by the preceding embodiment. For the technical details not described in detail in this embodiment, reference may be made to the preceding embodiment, and this embodiment has the same beneficial effects as the preceding embodiment.

An embodiment of the present disclosure provides a computer storage medium, where a computer program is stored on the computer storage medium, and when the program is executed by a processor, the effect processing method provided by any one of the preceding embodiments is implemented.

It should be noted that the computer-readable medium in the preceding description of the present disclosure may be a computer-readable signal medium, a computer-readable storage medium, or any combination thereof. The computer-readable storage medium may be, for example, but is not limited to, an electronic, magnetic, optical, electromagnetic, infrared, or semiconductor system, apparatus, device, or any combination thereof. More specific examples of the computer-readable storage medium may include, but are not limited to: an electrically connected portable computer magnetic disk with one or more wires, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that includes or stores a program, and the program may be used by or used in combination with an instruction execution system, apparatus, or device. In the present disclosure, the computer-readable signal medium may include a data signal propagated on a baseband or as a part of a carrier, and computer-readable program code is carried in the data signal. The data signal propagated in this way may be in multiple forms, and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted by any suitable medium, including, but not limited to: a wire, an optical cable, a radio frequency (RF), or any suitable combination thereof.

In some implementations, a client and a server may communicate using any currently known or future developed network protocol, such as the hypertext transfer protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The computer-readable medium may be contained in the electronic device, or it may exist alone without being assembled into the electronic device.

The computer-readable medium carries one or more programs, and when the one or more programs are executed by the electronic device, the electronic device: sends a target image to a first process and a second process when an effect trial request is received; processes the target image in the first process according to a first parameter, where the first parameter is a parameter adopted before the effect trial request is received; and processes the target image in the second process according to a second parameter to perform effect trial preview, where the second parameter is an effect parameter corresponding to the effect trial request. When the effect trial request is received, the target image is sent to the first process and the second process; the target image is processed in the first process according to the first parameter and rendering display is performed, where the first parameter is a parameter adopted before the effect trial request is received; and the target image is processed in the second process according to the second parameter and rendering display is performed to perform effect trial preview, where the second parameter is an effect parameter corresponding to the effect trial request.

The computer program code for performing the operations of the present disclosure may be written in one or more programming languages or a combination thereof. The programming languages include, but are not limited to, object-oriented programming languages such as Java, Smalltalk, and C++, and include conventional procedural programming languages such as “C” language or similar programming languages. The program code may be completely executed on a computer of a user, partially executed on a computer of a user, executed as an independent software package, partially executed on a computer of a user and partially executed on a remote computer, or completely executed on a remote computer or a server. In the case of involving the remote computer, the remote computer may be connected to the computer of the user through any kind of network, including a local area network (LAN) or a wide area network (WAN), or it may be connected to an external computer (for example, connected by using Internet provided by an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented by software or by hardware. The name of a unit does not constitute a limitation on the unit itself under certain circumstances. For example, the first acquiring unit may also be described as “a unit for acquiring at least two internet protocol addresses”.

The functions described above herein may be at least partially performed by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the preceding. More specific examples of the machine-readable storage medium may include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the preceding.

The preceding description is only preferred embodiments of the present disclosure and an explanation of the applied technical principles. Those skilled in the art should understand that the disclosure scope involved in the present disclosure is not limited to the technical solutions formed by the specific combination of the preceding technical features, and should also cover other technical solutions formed by any combination of the preceding technical features or their equivalent features without departing from the preceding disclosure concept. For example, the preceding features and the technical features disclosed in the present disclosure (but not limited to) with similar functions may be replaced each other to form a technical solution.

In addition, although the operations are depicted in a particular order, this should not be understood as requiring the operations to be performed in the particular order shown or in a sequential order. Under certain circumstances, multitasking and parallel processing may be beneficial. Similarly, although the preceding discussion contains several specific implementation details, these should not be interpreted as limiting the scope of the present disclosure. Certain features described in the context of separate embodiments may also be implemented in a single embodiment in combination. On the contrary, various features described in the context of a single embodiment may also be implemented in multiple embodiments individually or in any suitable sub combination.

Although the subject matter has been described in terms specific to the structural features and/or method logic actions, it should be understood that the subject matter defined in the appended claims is not necessarily limited to the specific features or actions described above. On the contrary, the specific features and actions described above are only exemplary forms of implementing the claims.

1. An effect processing method, comprising:
sending a target image to a first process and a second process in response to an effect trial request being received;
processing the target image in the first process according to a first parameter, the first parameter being a parameter adopted before the effect trial request is received; and
processing the target image in the second process according to a second parameter to perform effect trial preview, the second parameter being an effect parameter corresponding to the effect trial request.

2. The method of claim 1, wherein processing the target image in the first process according to the first parameter comprises:
performing, in the first process, effect processing on the target image according to the first parameter and performing rendering display on a target page; and,
processing the target image in the second process according to the second parameter comprises:
performing, in the second process, effect processing on the target image according to the second parameter and performing rendering display on the target page.

3. The method of claim 1, wherein a first image and a second image are presented on the target page, the first image is an image rendered after the target image is processed by using the first parameter, and the second image is an image rendered after the target image is processed by using the second parameter.

4. The method of claim 3, wherein the first image and the second image are displayed on the target page in a screen splitting manner or in a picture-in-picture manner, or the second image is superimposed over the first image.

5. The method of claim 1, wherein the method is applied to a first client; and when performing, in the first process, the effect processing on the target image according to the first parameter and performing the rendering display on a target page, the method further comprises:
pushing a first effect image obtained by performing effect processing on the target image in the first process to a server to make the server send the first effect image to a second client for rendering display.

6. The method of claim 1, wherein before sending the target image to the first process and the second process, the method further comprises:
creating the second process in response to a first operation for triggering an effect trial task, the first process and the second process being independent of each other in effect processing.

7. The method of claim 6, wherein the first operation comprises a trigger operation for an identification of the effect trial request presented on the target page.

8. The method of claim 1, wherein sending the target image to the first process and the second process comprises:
controlling, by the first process, an image acquiring apparatus to acquire the target image; and
sending the acquired target image to the first process, and sending, by the first process, the obtained target image to the second process across processes.

9. The method of claim 2, wherein performing, in the first process, the effect processing on the target image according to the first parameter and performing the rendering display on the target page comprises:
determining the first parameter adopted by the first process;
performing first effect processing on the target image by the first process according to the first parameter to obtain a first effect image; and
performing rendering display of the first effect image on the target page corresponding to the first process.

10. The method of claim 2, wherein performing, in the second process, the effect processing on the target image according to the second parameter and performing the rendering display on the target page comprises:
determining the second parameter selected for effect trial after the effect trial request is triggered;
performing second effect processing on the target image by the second process according to the second parameter to obtain a second effect image; and
rendering the second effect image of the second process to the target page for display by a preset display control, the preset display control being a control used for updating a display page across processes.

11. The method of claim 2, wherein before performing, in the second process, the effect processing on the target image according to the second parameter and performing the rendering display on the target page, the method further comprises:
determining the second parameter selected, in the second process, for effect trial from a plurality of effect parameters in response to a second operation for effect parameter selection after the effect trial request is triggered.

12. The method of claim 11, wherein the second operation is a selection operation for an identification of one effect parameter of identifications of at least two effect parameters presented on the target page.

13. The method of claim 2, wherein after performing, in the second process, the effect processing on the target image according to the second parameter and performing the rendering display on the target page, the method further comprises:
closing the second process and adjusting the first parameter adopted by the first process to the second parameter in response to a third operation for confirming adoption of the second parameter; and
performing, in the first process, the effect processing on the target image according to the second parameter and performing the rendering display on the target page.

14-16. (canceled)

17. An electronic device, comprising:
one or more processors;
a storage device for storing one or more programs, wherein,
the one or more programs, when executed by the one or more processors, cause the one or more processors to:
send a target image to a first process and a second process in response to an effect trial request being received;
process the target image in the first process according to a first parameter, the first parameter being a parameter adopted before the effect trial request is received; and
process the target image in the second process according to a second parameter to perform effect trial preview, the second parameter being an effect parameter corresponding to the effect trial request.

18. The device of claim 17, wherein the one or more programs causing the one or more processors to process the target image in the first process according to the first parameter comprise instructions to:
performing, in the first process, effect processing on the target image according to the first parameter and performing rendering display on a target page; and,
the one or more programs causing the one or more processors to process the target image in the second process according to the second parameter comprise instructions to:
perform, in the second process, effect processing on the target image according to the second parameter and perform rendering display on the target page.

19. The device of claim 17, wherein a first image and a second image are presented on the target page, the first image is an image rendered after the target image is processed by using the first parameter, and the second image is an image rendered after the target image is processed by using the second parameter.

20. The device of claim 19, wherein the first image and the second image are displayed on the target page in a screen splitting manner or in a picture-in-picture manner, or the second image is superimposed over the first image.

21. The device of claim 17, wherein the device is applied to a first client; and when performing, in the first process, the effect processing on the target image according to the first parameter and performing the rendering display on a target page, the one or more programs further cause the one or more processors to:
push a first effect image obtained by performing effect processing on the target image in the first process to a server to make the server send the first effect image to a second client for rendering display.

22. The device of claim 17, wherein before sending the target image to the first process and the second process, the one or more programs further cause the one or more processors to:
create the second process in response to a first operation for triggering an effect trial task, the first process and the second process being independent of each other in effect processing.

23. A non-transitory storage medium containing computer-executable instructions, wherein the computer-executable instructions, when executed by one or more computer processors, are used to cause the one or more computer processors to:
send a target image to a first process and a second process in response to an effect trial request being received;
process the target image in the first process according to a first parameter, the first parameter being a parameter adopted before the effect trial request is received; and
process the target image in the second process according to a second parameter to perform effect trial preview, the second parameter being an effect parameter corresponding to the effect trial request.
